(19) United States
(12) Patent Application Publication
(10) Pub. No.: US 2025/0069267 A1
(43) Pub. Date: Feb. 27, 2025

(54) COLOR VERIFICATION SYSTEM, COLOR VERIFICATION METHOD, AND NON-TRANSITORY RECORDING MEDIUM STORING COMPUTER-READABLE COLOR VERIFICATION PROGRAM

(71) Applicant: Konica Minolta, Inc., Tokyo (JP)

(72) Inventor: Kouichirou MATSUSHITA, Tokyo (JP)

(73) Assignee: Konica Minolta, Inc., Tokyo (JP)

(21) Appl. No.: 18/810,663

(22) Filed: Aug. 21, 2024

(30) Foreign Application Priority Data
Aug. 23, 2023 (JP) 2023-135351

(51) Int. Cl. G06T 7/90; G06K 15/12

(52) U.S. Cl. CPC G06T 7/90; G06K 15/129; G06T 2207/10008; G06T 2207/10024

(57) ABSTRACT

A color verification system capable of performing color verification corresponding to a required color quality level is provided. The color verification system for performing color verification of a specific image formed by an image forming apparatus includes an information processing apparatus, in which the information processing apparatus determines an allowable value to be used for color verification of a specific color forming the specific image, based on an attribute of the specific image formed with the specific color and a use of a printed product on which the specific image is formed.

### CROSS-REFERENCE TO RELATED APPLICATION

This application claims priority to Japanese Patent Application No. 2023-135351, filed on Aug. 23, 2023. The entire disclosure of Japanese patent Application No. 2023-135351 is incorporated herein by reference in its entirety.

### BACKGROUND OF THE INVENTION

### Technical Field

The present invention relates to a color verification system, a color verification method, and a non-transitory recording medium storing a computer-readable color verification program.

### Description of Related Art

As a technology for verifying color qualities of images formed by an image forming apparatus, there is a technology disclosed in Japanese Unexamined Patent Application Publication No. 2022-172703. The Japanese Unexamined Patent Application Publication No. 2022-172703 describes the following procedure for color verification. First, a user sets data of a color reference to be used in performing color verification. The data of the color reference includes reference names and allowable conditions for each of the reference names. The allowance conditions are allowable values of an average color difference, a maximum color difference, and the like.

A CPU of a client computer calculates a color difference between colorimetric data of a color patch subjected to colorimetry using a colorimetry unit and a reference value of the color reference set by the user. Note that the colorimetric data and the reference value are Lab values in a Lab color space. Next, the CPU of the client computer compares the calculated color difference with an allowable value of the color difference of the color reference and determines that the calculated color difference is satisfactory (OK) in a case where the calculated color difference is equal to or smaller than the allowable value.

### SUMMARY OF THE INVENTION

However, the data of the color reference used for the color verification includes the reference names and the allowable conditions for each of the reference names, and only one allowable condition is set for each reference name. Therefore, it is not possible to perform color verification in consideration of for which purpose of a printed product and for which type of image a color having the reference name is used for forming. Thus, even in a case where a color quality level required for an image to be formed or a printed product is not high, when a determination result of color verification is unsatisfactory, an operator having expertise needs to take time to adjust colors.

It is therefore an object of the present invention to provide a color verification system, a color verification method, and a non-transitory recording medium storing a computer-readable color verification program, which are capable of performing color verification under an allowable condition corresponding to a required color quality level.

The present invention for achieving such an object includes a color verification system for performing color verification of a specific image formed by an image forming apparatus. According to the present invention, the color verification system includes an information processing apparatus, in which the information processing apparatus determines an allowable value to be used for color verification of a specific color forming the specific image, based on an attribute of the specific image formed with the specific color and a use of a printed product on which the specific image is formed.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a diagram illustrating an overall configuration of a color verification system according to a first embodiment;

FIG. 2 is a diagram illustrating a color verification information table held in a server apparatus of the color verification system according to the first embodiment;

FIG. 3 is a flowchart illustrating a color verification method according to the first embodiment;

FIG. 4 is a diagram illustrating an example of a verification result displayed on a display;

FIG. 5 is a flowchart illustrating a main procedure of a color verification method according to a second embodiment; and

FIG. 6 is a diagram illustrating grouping of correct values in a color verification method according to a third embodiment.

### DETAILED DESCRIPTION

Hereinafter, each embodiment of the present invention will be described in detail with reference to the drawings. In each of the embodiments, the same constituent elements are denoted by the same reference signs, and redundant description will be omitted.

### First Embodiment

### <Color Verification System>

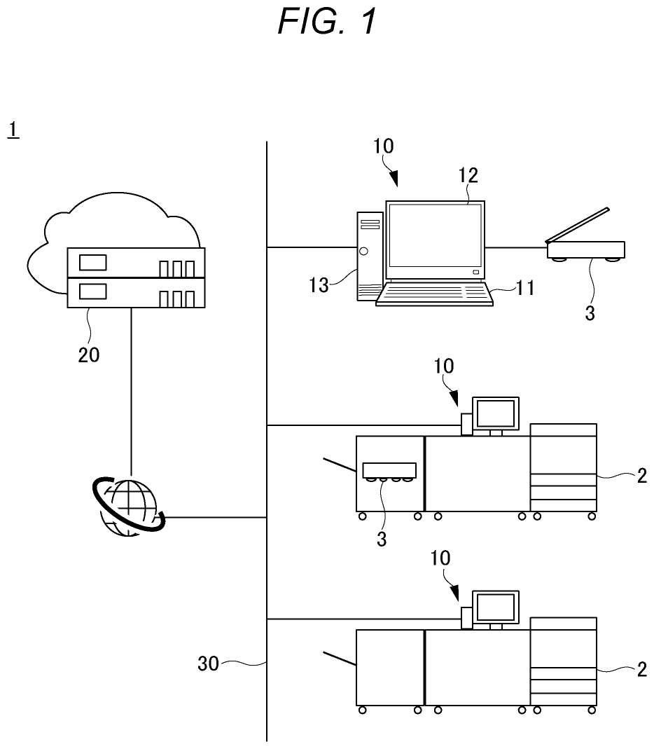

FIG. 1 is a diagram of an overall configuration of a color verification system 1 according to a first embodiment. The color verification system 1 illustrated in FIG. 1 is a system for performing color verification of a special color (hereinafter, referred to as a pseudo special color) formed by adjustment of process color ink prior to image formation using process color ink. The color verification system 1 includes an information processing apparatus 10 and a server apparatus 20. The information processing apparatus 10 and the server apparatus 20 are connected to each other via a network and a communication line 30. The number of information processing apparatuses 10 is not limited to one, and it is preferable that a plurality of information processing apparatuses 10 are connected to the server apparatus 20 via the network and the communication line 30.

### [Information Processing Apparatus 10]

Each information processing apparatus 10 is a so-called computer and may be a client computer owned by each user who uses the color verification system 1. The information processing apparatus 10 may be incorporated in, for example, an image forming apparatus 2. The information processing apparatus 10 may be connected to a colorimeter 3. Note that the colorimeter 3 may be incorporated in the image forming apparatus 2.

Each information processing apparatus 10 includes an operation part 11, a display 12, and an information processing section 13. The information processing section 13 includes a central processing unit (CPU), a read only memory (ROM), a random access memory (RAM), and a network interface. The CPU reads a predetermined program from the ROM and develops the program in the RAM, and executes the developed program, whereby the information processing section 13 verifies a color.

The information processing section 13 determines an allowable value for color verification for a specific color based on an attribute of a specific image formed with the specific color and a use of a printed product on which the specific image is formed. The specific color is a pseudo special color formed by adjustment of the process color ink, and the specific image is a special color image formed with the pseudo special color. The information processing section 13 also determines whether the color of the image formed with the pseudo special color falls within an allowable value range. Note that a detailed procedure of the color verification by the information processing section 13 will be described in detail in description of a color verification method described later.

### [Server Apparatus 20]

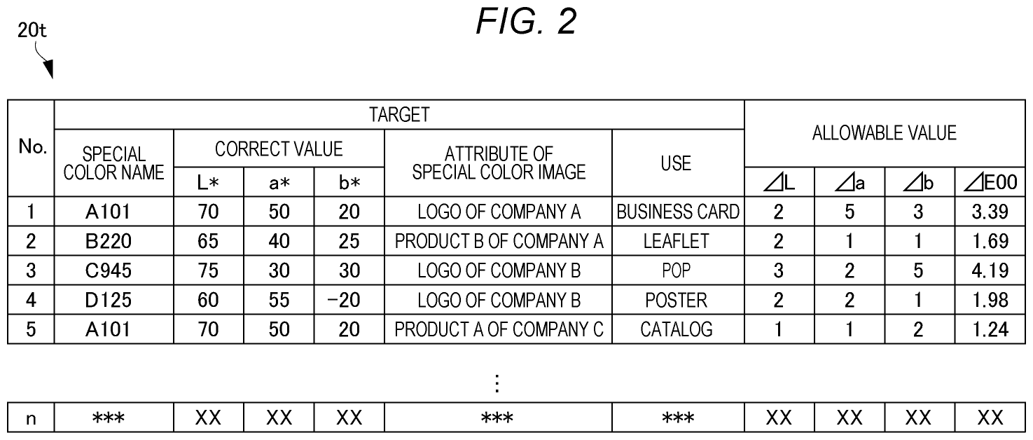

The server apparatus 20 is preferably, for example, a server apparatus on a cloud, and holds a database for color verification. FIG. 2 is a diagram illustrating a color verification information table 20t held in the server apparatus 20 of the color verification system 1 according to the first embodiment. The color verification information table 20t holds target information and allowable value information with information numbers (No.) assigned thereto. The target information refers to information regarding a special color image formed with a pseudo special color among images printed and formed by the image forming apparatus 2, and herein refers to information regarding a special color image formed by using process color ink in place of special color ink.

The target information includes information of a special color name, a correct value, an attribute, and a use in the special color image. The special color name is the name of special color ink. The correct value indicates the color of the special color ink targeted by the pseudo special color, and is indicated by a Lab value (L*, a*, b*). The attribute is the type of the special color image, for example, a type indicating whether the special color image is an image indicating brand information such as a mark, a brand, a trademark, a company logo, or a product logo, or an image of a product itself. The use is the form of a printed product on which the special color image is printed. Specific examples of the use are a business card, a leaflet, a pop, a poster, a catalog, and the like.

The allowable value information is an allowable value (ΔL, Δa, Δb, ΔE00) of a color difference between a colorimetric value of the pseudo special color formed by the adjustment of the process color ink and the correct value of the special color targeted by the pseudo special color. The allowable value is a value set for each special color, each attribute, and each use. That is, in a case where special color names and correct values are the same, but attributes of special color images and uses of printed products on which the special color images are formed are different, allowable values associated with information numbers (No.) may be different. In this case, a range of an allowable value is set to be narrow for an attribute or a use for which a high color quality level is required. Specifically, No. 1 and No. 5 of the information numbers (No.) have the same special color, but attributes (logo of company A and product of company C) of special color images are different, and uses (business card and catalog) are different, and thus allowable values are different values.

### <Color Verification Method>

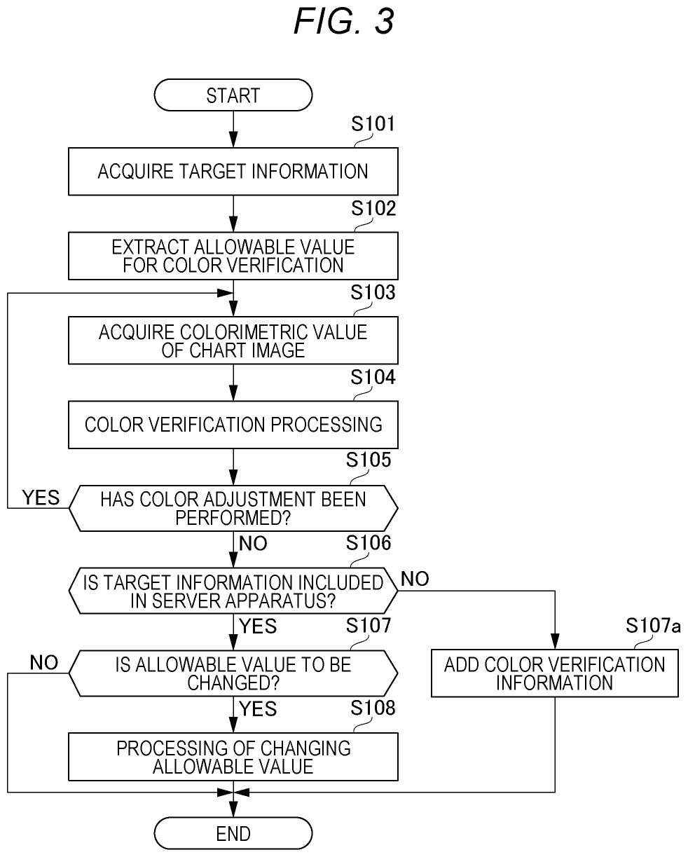

FIG. 3 is a flowchart illustrating the color verification method according to the first embodiment. A procedure illustrated in this flowchart is executed by a color verification program held in each information processing apparatus 10 in the color verification system 1 described with reference to FIG. 1. The color verification method according to the first embodiment will be described below with reference to FIGS. 1 and 2 in accordance with the procedure illustrated in FIG. 3.

### [Step S101]

In step S101, the information processing section 13 acquires target information regarding color verification. The target information is information regarding a special color image formed by substituting a process color for a special color among images printed and formed by the image forming apparatus 2. The target information acquired here indicates a correct value of the color of the special color image or the special color name, the attribute of the special color image, and a use of a product on which the special color image is formed.

The information regarding the special color image is acquired by an input from the operation part 11 by the user.

### [Step S102]

In step S102, the information processing section 13 extracts, based on the target information acquired in step S101, an allowable value for color verification from the information held in the server apparatus 20. In this case, the information processing section 13 selects, from the color verification information table 20t (FIG. 2) held in the server apparatus 20, an information number (No.) having information matching the target information acquired in step S101. Then, the information processing section 13 extracts an allowable value held in association with the selected information number (No.).

In a case where information matching the target information acquired in step S101 is not present in the color verification information table 20t held in the server apparatus 20, the information processing section 13 selects an information number (No.) that has information indicating a similar attribute to the attribute indicated in the target information acquired in step S101 or has information indicating a use matching the use indicated in the target information acquired in step S101. Here, the similar attributes indicates that items other than company names indicated in the attributes match. In a case where a plurality of selectable information numbers (No.) are present, the information processing section 13 preferentially selects an information number (No.) having the matching special color name or correct value, and then preferentially selects an information number having the matching use. In this case, the information processing section 13 extracts allowable values of the selected information numbers (No.) as provisional allowable values.

### [Step S103]

In step S103, the information processing section 13 acquires a colorimetric value of a chart image. The chart image is a test image obtained by printing the correct value of the color of the special color image acquired in step S101 or the color of the special color name acquired in step S101 with use of the pseudo special color obtained by adjusting the process color ink. The colorimetric value of the chart image acquired by the information processing section 13 is a value obtained by measuring the color of the chart image with the colorimeter 3. The information processing section 13 acquires the colorimetric value of the chart image from the colorimeter 3 connected to the information processing apparatus 10 or the colorimeter 3 incorporated in the image forming apparatus 2, or acquires the colorimetric value of the chart image by an input from the operation part 11 by the user.

### [Step S104]

In step S104, the information processing section 13 performs color verification based on the correct value of the target information acquired in step S101 and the colorimetric value acquired in step S103. The color verification by the information processing section 13 is as follows.

First, the information processing section 13 calculates color differences between the correct value of the target information acquired in step S101 and the colorimetric value 12b acquired in step S103. Next, the information processing section 13 compares the calculated color differences with the allowable value (or the provisional allowable values) extracted in step S102, and determines whether all the color differences are within a range of the allowable value (or the provisional allowable values). Next, in a case where all of the calculated color differences or the color difference ΔE00 are or is within the range of the allowable value (or the provisional allowable values), the information processing section 13 determines that the verification result is satisfactory (OK). The information processing section 13 causes the display 12 to display the verification result.

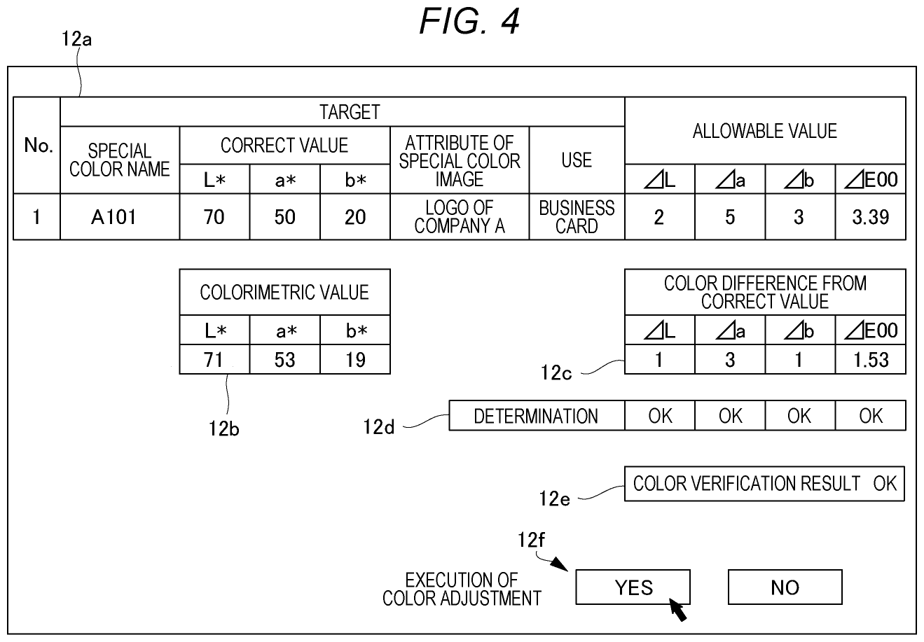

FIG. 4 is a diagram illustrating an example of the verification result displayed on the display 12. As illustrated in FIG. 4, the display 12 displays color verification information 12a including the target information acquired in step S101 and the allowable value (or the provisional allowable values) extracted in step S102. In addition, the display 12 displays the colorimetric value 12b acquired in step S103, the calculated color differences 12c, and a determination result 12d indicating whether or not the color differences are within the range of the allowable value. The display 12 also displays a color verification result 12e. In a case where the allowable value extracted in step S102 is a provisional allowable value, the information number (No.) of the color verification information 12a is blank.

### [Step S105]

In step S105, the information processing section 13 determines whether or not to perform color adjustment. This determination is made by an input from the operation part 11 by the user. In this case, for example, as illustrated in FIG. 4, the display 12 displays a selection section 12f for selecting whether or not to perform the color adjustment together with the color verification result 12c.

The user refers to the above-described chart image (S103) together with the determination result 12d and the color verification result 12e displayed on the display 12, and the information processing section 13 determines whether or not to perform the color adjustment. In a case where the user determines to perform the color adjustment, the user selects [YES] in the selection section 12f.

Thus, the information processing section 13 returns to step S103 (FIG. 3).

In this case, the user performs the color adjustment of the process color ink. In this color adjustment, for example, the maximum density, gradation, and color conversion table of each process color ink are corrected such that the colorimetric value falls within the allowable value extracted in step S102. Thereafter, the user prints and forms a chart image using the color-adjusted process color ink, and performs colorimetry on the chart image. In step S103, the information processing section 13 acquires a colorimetric value of the chart image obtained by the colorimetry. Thereafter, the information processing section 13 repeats step S104 and subsequent steps.

On the other hand, in a case where the user selects “NO” in the selection section 12f (see FIG. 4), the information processing section 13 determines not to perform the color adjustment (NO), and proceeds to step S106.

### [Step S106]

In step S106, the information processing section 13 determines whether the target information acquired in step S101 is included in the color verification information table 20t (see FIG. 2) of the server apparatus 20. In this case, in a case where the information processing section 13 has been able to select, in step S102, an information number (No.) having information that matches the target information acquired in step S101, the information processing section 13 determines that the target information is present (YES), and proceeds to step S107.

On the other hand, in a case where the information processing section 13 has extracted the provisional allowable value in step S102, that is, in a case where the information number (No.) of the color verification information 12a illustrated in FIG. 4 is blank, the information processing section 13 determines that the target information acquired in step S101 is not present in the server apparatus 20 (NO). Then, the information processing section 13 proceeds to step S107a.

### [Step S107a]

In step S107a, the information processing section 13 assigns a new information number (No.) to the target information acquired in step S101 and the allowable value, and adds the color verification information to the color verification information table 20t (FIG. 2) of the server apparatus 20. Here, the allowable value to which the new information number (No.) is assigned is any one of the provisional allowable value extracted in step S102, the color difference calculated in step S104, and a value set by the user. The information processing section 13 adds the color verification information having the new information number (No.) to the color verification information table 20t (FIG. 2) in the server apparatus 20, and ends the process.

### [Step S107]

On the other hand, in step S107, the information processing section 13 determines whether to change the allowable value. This allowable value is the allowable value extracted in step S102. This determination is made by an input from the operation part 11 by the user. In this case, the display 12 displays a selection section (not illustrated) for selecting whether or not to change the allowable value. In a case where the user selects to change the allowable value (YES), the information processing section 13 proceeds to step S108. On the other hand, in a case where the user selects not to update the allowable value (NO), the information processing section 13 ends the process.

### [Step S108]

In step S108, the information processing section 13 causes the display 12 to display an operation image for changing the allowable value (not illustrated). In this case, the information processing section 13 causes the display 12 to display the color verification information 12a (see FIG. 4) of the information number (No.) selected in step S101 and a change execution button. Of these, the color verification information 12a is displayed so that the allowable value can be rewritten.

Thus, even in a case where the color verification result is determined to be satisfactory (OK) in the color verification processing in step S104, the user can rewrite the allowable value in the color verification information 12a of the corresponding information number (No.). The user refers to, for example, the above-described chart image (S103) together with the determination result 12d and the color verification result 12e illustrated in FIG. 4 and changes the current allowable value to a smaller value or a larger value. Furthermore, the user selects the execution button after rewriting the allowable value. Thus, the information processing section 13 changes the allowable value of the corresponding information number (No.) in the color verification information table 20t held in the server apparatus 20, and ends the process.

In this step S108, the information processing section 13 may cause the display 12 to display a selection indication as to whether or not the color difference calculated in step S104 is to be set as a new allowable value. In this case, when the user selects to set the color difference calculated in step S104 as a new allowable value, the information processing section 13 rewrites the allowable value in the color verification information table 20t to the color difference calculated in step S104, and ends the process.

### Effects of First Embodiment

According to the above-described first embodiment, in a case where a special color image is formed by substituting process color ink for special color ink, color verification corresponding to a required color quality level can be performed by setting an allowable value for each attribute of the special color image and each use of a printed product on which the special color image is formed and performing color verification. As a result, it is possible to reduce unnecessary color adjustment based on a determination result at a color quality level higher than necessary.

### Second Embodiment

A second embodiment is a modification example of the first embodiment, and is an example of automating the acquisition of the target information in step S101 illustrated in the flowchart of FIG. 3 in the color verification method in the first embodiment.

### <Color Verification Method>

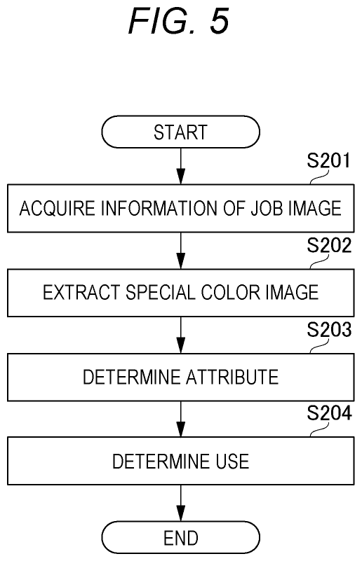

FIG. 5 is a flowchart illustrating a main procedure of a color verification method according to the second embodiment, and illustrates a procedure performed instead of step S101 of the flowchart of FIG. 3. The procedure illustrated in this flowchart is a procedure performed by the color verification program held in the information processing section 13 of each information processing apparatus 10 of the color verification system 1 described with reference to FIG. 1. The color verification method according to the second embodiment will be described below with reference to FIGS. 1 and 2 in accordance with the procedure illustrated in FIG. 5.

### [Step S201]

In step S201, the information processing section 13 acquires information of a job image to be printed by the image forming apparatus 2. The information processing section 13 may acquire the information of the job image via the network interface of the information processing apparatus 10, or may acquire the information of the job image from an image reader of the image forming apparatus 2 in a case where the information processing apparatus 10 is incorporated in the image forming apparatus 2.

### [Step S202]

In step S202, the information processing section 13 extracts a special color image from the job image acquired in step S201. In this case, the server apparatus 20 includes a database regarding the special color image. The information processing section 13 extracts the special color image in the job image by referring to the database regarding the special color image included in the server apparatus 20. In a case where the server apparatus 20 does not have the database regarding the special color image, the information processing section 13 may extract the special color image from the job image by performing an image search on the network. This network may be a global network connected to the external Internet.

### [Step S203]

In step S203, the information processing section 13 determines an attribute of the special color image extracted in step S202. The information processing section 13 extracts the attribute associated with the special color image extracted in step S202 with reference to the database regarding the special color image included in the server apparatus 20. Furthermore, in a case where the server apparatus 20 does not have the database regarding the special color image, the information processing section 13 may determine the attribute of the special color image by performing an image search on the network.

### [Step S204]

In step S204, the information processing section 13 determines a use of a printed product on which an image is formed by the image forming apparatus 2, based on the information of the job image acquired in step S201. In this case, the information processing section 13 determines the use of the printed product based on the size of the printed product and the overall image to be formed, and ends the process.

Thereafter, the information processing section 13 proceeds to step S102 in FIG. 3. In this case, the information processing section 13 extracts an allowable value for color verification based on the attribute determined in step S203 and the use determined in step S204 in the target information. That is, the information processing section 13 selects an information number (No.) having information that matches the attribute determined in step S203 and the use determined in step S204 from the color verification information table 20t (FIG. 2) held in the server apparatus 20. Then, the information processing section 13 extracts an allowable value held in association with the selected information number (No.). As described in step S102 in the first embodiment, the allowable value may be a provisional allowable value. Thereafter, the information processing section 13 performs the procedure described in the first embodiment.

### Effects of Second Embodiment

According to the second embodiment, in addition to the effects of the first embodiment, it is possible to automate acquisition of information for color verification.

### Third Embodiment

A third embodiment is a modification example of the first embodiment, and is an embodiment example of the color verification method in a case where color verification information including the target information is not present in the color verification information table 20t illustrated in FIG. 2 in the color verification method according to the first embodiment.

As described in the first embodiment, in step S102 of FIG. 3, the information processing section 13 extracts an allowable value for color verification from information held in the server apparatus 20, based on the target information acquired in step S101. In this case, in a case where information matching the target information acquired in step S101 is not present in the color verification information table 20t held in the server apparatus 20, the information processing section 13 determines the allowable value as follows in the third embodiment.

That is, the information processing section 13 determines the allowable value based on the correct value in the target information acquired in step S101 and the history information of the color verification. In this case, the server apparatus 20 has data regarding past color verification. This data is data in which correct values of colors for which color verification has been performed in the past are plotted in the Lab color space.

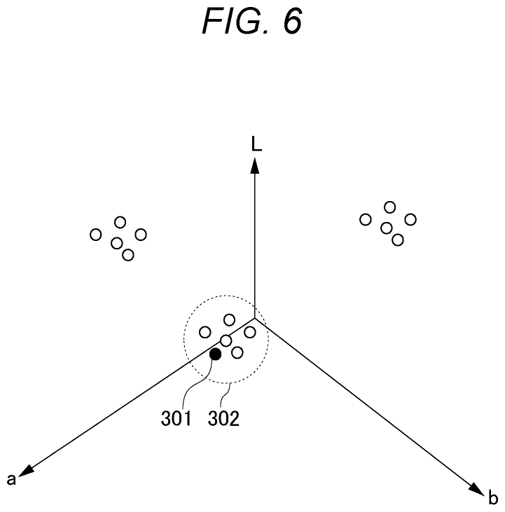

FIG. 6 is a diagram illustrating grouping of correct values in a color verification method according to the third embodiment. As illustrated in FIG. 6, the information processing section 13 plots the correct value 301 acquired in step S101 in the Lab color space on the database, and groups (clusters) data of past correct values close to the correct value 301 into a group 302. A program for the grouping is not particularly limited.

The information processing section 13 calculates an average value of allowable values corresponding to the respective correct values within the group 302, and sets the average value as an allowable value of the correct values.

### Effects of Third Embodiment

According to the third embodiment, even in a case where the color verification information including the target information is not present in the color verification information table 20t of the server apparatus 20, an allowable value can be set based on the history information of the past color verification.

Although embodiments of the present invention have been described and illustrated in detail, the disclosed embodiments are made for purposes of illustration and example only and not limitation. The scope of the present invention should be interpreted by terms of the appended claims.

What is claimed is:

1. A color verification system for performing color verification of a specific image formed by an image forming apparatus, the color verification system comprising
an information processing apparatus, wherein
the information processing apparatus determines an allowable value to be used for color verification of a specific color forming the specific image, based on an attribute of the specific image formed with the specific color and a use of a printed product on which the specific image is formed.

2. The color verification system according to claim 1, wherein
the specific image is formed by using process color ink in place of special color ink, and
the specific color is a special color.

3. The color verification system according to claim 1, wherein the attribute of the specific image is a type of the specific image.

4. The color verification system according to claim 1, further comprising
a server apparatus that holds allowable values set in accordance with at least one of the attribute of the specific image and the use of the printed product, wherein
the information processing apparatus extracts one of the allowable values held in the server apparatus based on information regarding the attribute of the specific image and the use of the printed product.

5. The color verification system according to claim 4, wherein
the server apparatus holds a correct value of the specific color forming the specific image in association with the attribute of the specific image and the use of the printed product, and
the information processing apparatus determines whether or not a color difference between a colorimetric value of the image of the specific color formed by the image forming apparatus and the correct value of the specific color is within a range of the extracted allowable value.

6. The color verification system according to claim 5, wherein the allowable value for the color verification is represented by ΔL, Δa, Δb, and ΔE00 which are differences from coordinates of the correct value in a Lab color space.

7. The color verification system according to claim 1, wherein the information processing apparatus acquires document image data of a print job for the image forming apparatus, extracts the specific image from the acquired document image data, and determines the attribute of the extracted specific image.

8. The color verification system according to claim 7, further comprising a server apparatus that holds a database regarding the specific image, wherein the information processing apparatus extracts the specific image from the document image data with reference to the database, and determines the attribute of the extracted specific image.

9. The color verification system according to claim 7, wherein the information processing apparatus extracts the specific image by performing an image search on a network, and determines the attribute of the extracted specific image.

10. The color verification system according to claim 1, wherein the information processing apparatus determines the use of the printed product based on size information of the printed product and layout information of an image on the printed product.

11. The color verification system according to claim 1, wherein the information processing apparatus determines the allowable value to be used for the color verification of the specific color based on history information of the color verification.

12. The color verification system according to claim 11, wherein the information processing apparatus plots, in a Lab color space, correct values of specific colors for which color verification has been performed based on the history information, groups correct values close in distance to a correct value of a specific color to be subjected to the color verification in the Lab color space, and determines an average of allowable values corresponding to the grouped correct values to be the allowable value to be used for the color verification of the specific color to be subjected to the color verification.

13. The color verification system according to claim 11, wherein the information processing apparatus records the history information of the color verification in a server apparatus on a cloud.

14. A color verification method for a specific image formed by an image forming apparatus, the color verification method comprising: determining, based on an attribute of the specific image formed with a specific color and a use of a printed product on which the specific image is formed, an allowable value to be used for color verification of the specific color forming the specific image.

15. The color verification method according to claim 14, wherein
a server apparatus holds allowable values set in accordance with at least one of the attribute of the specific image and the use of the printed product, and
an information processing apparatus extracts one of the allowable values held in the server apparatus based on information regarding the attribute of the specific image and the use of the printed product.

16. The color verification method according to claim 15, wherein
the server apparatus holds a correct value of the specific color forming the specific image in association with the attribute of the specific image and the use of the printed product, and
the information processing apparatus determines whether or not a color difference between a colorimetric value of the image of the specific color formed by the image forming apparatus and the correct value of the specific color is within a range of the extracted allowable value.

17. A non-transitory recording medium storing a computer-readable color verification program for a specific image formed by an image forming apparatus, the color verification program causing a computer to execute causing an information processing apparatus to determine, based on an attribute of the specific image formed with a specific color and a use of a printed product on which the specific image is formed, an allowable value to be used for color verification of the specific color forming the specific image.

18. The non-transitory recording medium storing the computer-readable color verification program according to claim 17, wherein the color verification program causes a server apparatus to hold allowable values set in accordance with at least one of the attribute of the specific image and the use of the printed product, and causes the information processing apparatus to extract one of the allowable values held in the server apparatus based on information regarding the attribute of the specific image and the use of the printed product.

19. The non-transitory recording medium storing the computer-readable color verification program according to claim 18, wherein the color verification program causes the server apparatus to hold a correct value of the specific color forming the specific image in association with the attribute of the specific image and the use of the printed product, and causes the information processing apparatus to determine whether or not a color difference between a colorimetric value of the image of the specific color formed by the image forming apparatus and the correct value of the specific color is within a range of the extracted allowable value.
